(19) United States
(12) Patent Application Publication
(10) Pub. No.: US 2022/0068273 A1
(43) Pub. Date: Mar. 3, 2022

(54) CONFIGURING A PROXY FOR HANDS-FREE OPERATION

(71) Applicant: MOTOROLA SOLUTIONS, INC., Chicago, IL (US)

(72) Inventor: YEN HSIANG CHEW, BAYAN LEPAS (MY)

(21) Appl. No.: 17/009,804

(22) Filed: Sep. 2, 2020

(51) Int. Cl. G10L 15/22; H04W 4/80; G10L 15/30; G06F 16/61; G06F 16/68

(52) U.S. Cl. CPC G10L 15/22; H04W 4/80; H04W 84/20; G06F 16/61; G06F 16/686; G10L 15/30

(57) ABSTRACT

A method and apparatus for configuring a proxy device is provided herein. During operation, a proxy device will maintain a remote device voice control database comprising user-interface (UI) commands used to control the remote device. When a user invokes an action on the remote device using a non-vocal control of the remote device (e.g. by not using a voice command but instead pressing the recording button on a camera), the remote device advertises a command associated with the performed user action to the proxy device. The proxy device checks the database for the advertised command. If the command is not found in the database, the proxy device dynamically requests that the user record a voice utterance to associate with the command. The recommended voice utterance and its associated command are updated in the body-worn camera voice control database of the proxy device.

### BACKGROUND

Existing solution for configuring a first host device (e.g. a proxy device) to function as an utterance proxy for a second device is non-intuitive and inflexible for normal proxy device users. Normal users may not have the technical knowledge to properly setup or customize an utterance on the proxy to suit the needs of communicating with other remote devices. Therefore, a need exists for a method and apparatus for configuring a proxy for hands-free operation of a second device.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 illustrates an operating environment for the present invention.

FIG. 2 is a block diagram showing a personal-area network.

FIG. 3 illustrates a personal-area network.

FIG. 4 is a block diagram of a hub device within a personal-area network.

FIG. 5 is a block diagram of a hub device within a personal-area network.

FIG. 6 is a flow chart showing operation of the hub device of FIG. 4 and FIG. 5.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In order to address the above-mentioned need, a method and apparatus for configuring a proxy device for hands-free operation of a remote device (i.e., physically remote from the proxy device) is provided herein. During operation, a proxy device will maintain a remote device voice control database comprising user-interface (UI) commands used to control the remote device. When a user invokes an action on the remote device using a non-vocal control of the remote device (e.g. by not using a voice command but instead pressing the recording button on a camera), the remote device advertises a command associated with the performed user action to the proxy device. The proxy device checks the database for the advertised command. If the command is not found in the database, the proxy device dynamically requests that the user record a voice utterance to associate with the command. The recommended voice utterance and its associated command are updated in the body-worn camera voice control database of the proxy device.

The user can now invoke the action on the remote device by speaking the recommended voice utterance to the proxy device. More particularly, when the proxy device hears the utterance, the proxy device will interpret the utterance and issue the command to the remote device.

Consider an example where a body-worn camera is connected to a police radio that serves as a proxy for utterances for the body-worn camera. The radio contains a body-worn camera database comprising commands for the body-worn camera and their associated utterances. When the user invokes an action on the camera using a non-vocal command of the body-worn camera (e.g. presses the recording button of a body-worn camera), the body-worn camera advertises a command associated with the performed user action to the radio via, for example, a personal-area network (PAN) interface.

The radio checks its body-worn camera database for the advertised command. If the command is not found, the radio dynamically recommends a new voice utterance (e.g. “start record”) to associate with the command. Alternatively, the user may be requested to input a desired utterance instead.

The recommended new utterance (or the desired utterance) and its associated command are updated in the body-worn camera database within the radio. From this point on, the user can invoke the same action on the body-worn camera (e.g. start recording) by speaking to the radio “start record” (or the desired utterance). The radio interprets the uttered “start record” and issues the command to the body-worn camera via their PAN interface to invoke control of the body-worn camera.

It should be noted that when several devices are simultaneously attached to the proxy device, a name of the attached device may need to be uttered before the command is uttered. In the above example, the body-worn camera name followed by an utterance (e.g. “body camera start record”) will be used to control the body-worn camera.

The above will be discussed in more detail below, starting with example system and device architectures of the system in which the embodiments may be practiced, followed by an illustration of processing blocks for achieving an improved technical method, device, and system for configuring a proxy for hands-free operation. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

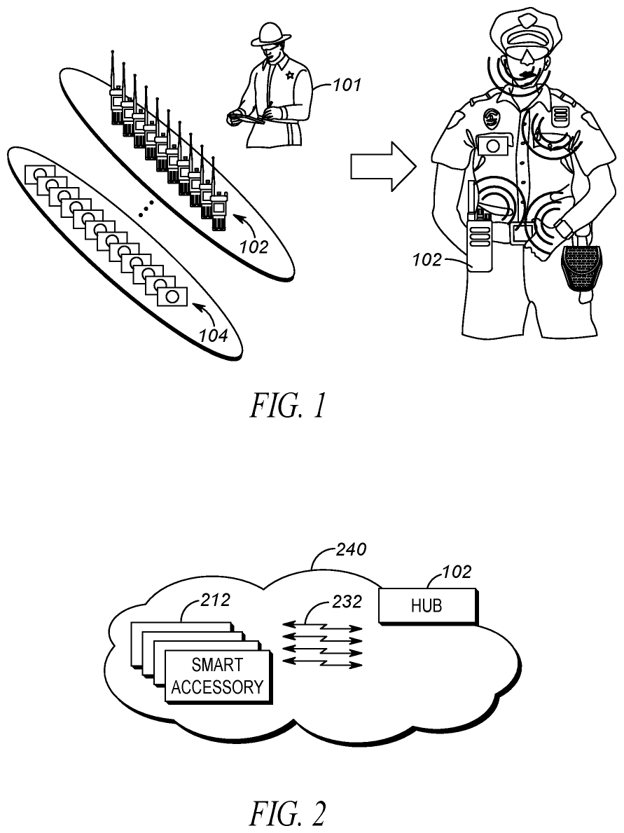

Referring now to the drawings, FIG. 1 illustrates an operational environment for the present invention. As shown, a public safety officer 101 will be equipped with certain connected devices that determine various physical and environmental conditions surrounding the public-safety officer. These conditions are generally reported back to a dispatch center so an appropriate action may be taken. For example, future police officers may have a sensor that determines when a gun is drawn. Upon detecting that an officer has drawn their gun, a notification may be sent back to the dispatch operator so that, for example, other officers in the area may be notified of the situation.

It is envisioned that the public-safety officer will have an array of shelved devices available to the officer at the beginning of a shift. The officer will select the devices off the shelf, and form a personal area network (PAN) with the devices that will accompany the officer on his shift. For example, the officer may pull a gun-draw sensor, a body-worn camera, a wireless microphone, a smart watch, an internet of things (IoT) device, a police radio, smart handcuffs, a man-down sensor, . . . , etc. All devices pulled by the officer will be configured (connected) to form a PAN by associating (pairing) with each other and communicating wirelessly among the devices. At least one device may be configured with a digital assistant capable of hearing utterances and performing actions based on the utterances. In a preferred embodiment, the PAN comprises more than two devices, so that many devices are connected via the PAN simultaneously.

A method called bonding is typically used for recognizing specific devices and thus enabling control over which devices are allowed to connect to each other when forming the PAN. Once bonded, devices then can establish a connection without user intervention. A bond is created through a process called “pairing”. The pairing process is typically triggered by a specific request by the user to create a bond from a user via a user interface on the device.

As shown in FIG. 1, public-safety officer 101 has an array of devices to use during the officer's shift. For example, the officer may pull one radio 102 and one camera 104 for use during their shift. Other devices may be pulled as well. As shown in FIG. 1, officer 101 will preferably wear the devices during a shift by attaching the devices to clothing. These devices will form a PAN throughout the officer's shift.

FIG. 2 depicts PAN 240. PAN 240 includes hub (PAN primary device) 102, local devices (subordinate devices that serve as smart accessories/sensors) 212, and communication links 232. In a preferred embodiment of the present invention, hub 102 and devices 212 form PAN 240, with communication links 232 between devices 212 and hub 102 taking place utilizing a short-range communication system protocol such as a Bluetooth communication system protocol.

Hub 102 serves as a PAN primary device, and may be any suitable computing and communication device configured to engage in wired and/or wireless communication with one or more local device 212 via the communication link 232. Hub 102 is also configured with a natural language processing (NLP) engine that serves as a digital assistant configured to determine the intent and/or content of the any utterances received by users. The NLP engine may also analyze oral queries and/or statements received by any user and provide responses to the oral queries and/or take other actions in response to the oral statements.

Digital assistants may provide the user with a way of using voice to control devices. The control of devices may be in response to an utterance posed by the user. As some existing examples, electronic digital assistants such as Siri provided by Apple, Inc.® and Google Now provided by Google, Inc.®, are software applications running on underlying electronic hardware that are capable of understanding natural language, and may complete electronic tasks in response to user voice inputs, among other additional or alternative types of inputs.

Devices 212 and hub 102 may comprise any device capable of forming a PAN. For example, devices 212 may comprise a gun-draw sensor, a body temperature sensor, an accelerometer, a heart-rate sensor, a breathing-rate sensor, a camera, a GPS receiver capable of determining a location of the user device, smart handcuffs, a clock, calendar, environmental sensors (e.g. a thermometer capable of determining an ambient temperature, humidity, presence of dispersed chemicals, radiation detector, etc.), an accelerometer, a biometric sensor (e.g., wristband), a barometer, speech recognition circuitry, a smart watch, a gunshot detector, . . . , etc.

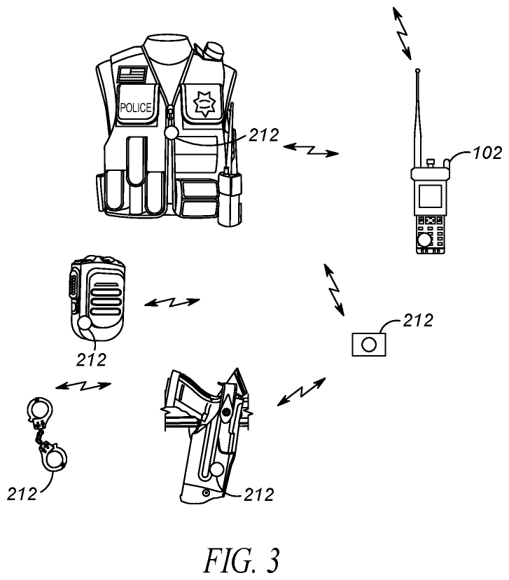

FIG. 3 depicts another view of a personal-area network 240 of FIG. 2. Personal-area network comprises a very local-area network that has a range of, for example 10 feet. As shown in FIG. 3, a radio device 102 that functions as a hub is provided; and various devices 212 are that attach to clothing utilized by a public-safety officer. In this particular example, a bio-sensor is located within a police vest, a voice detector is located within a police microphone, smart handcuffs 212 are usually located within a handcuff pouch (not shown), a gun-draw sensor is located within a holster, and a camera 104 is provided.

Devices 212 and hub 102 form a PAN 240. PAN 240 preferably comprises a Bluetooth PAN. Devices 212 and hub 102 are considered Bluetooth devices in that they operate using a Bluetooth, a short range wireless communications technology at the 2.4 GHz band, commercially available from the “Bluetooth special interest group”. Devices 212 and hub 102 are connected via Bluetooth technology in an ad hoc fashion forming a PAN. Hub 102 serves as a primary device while devices 212 serve as subordinate devices.

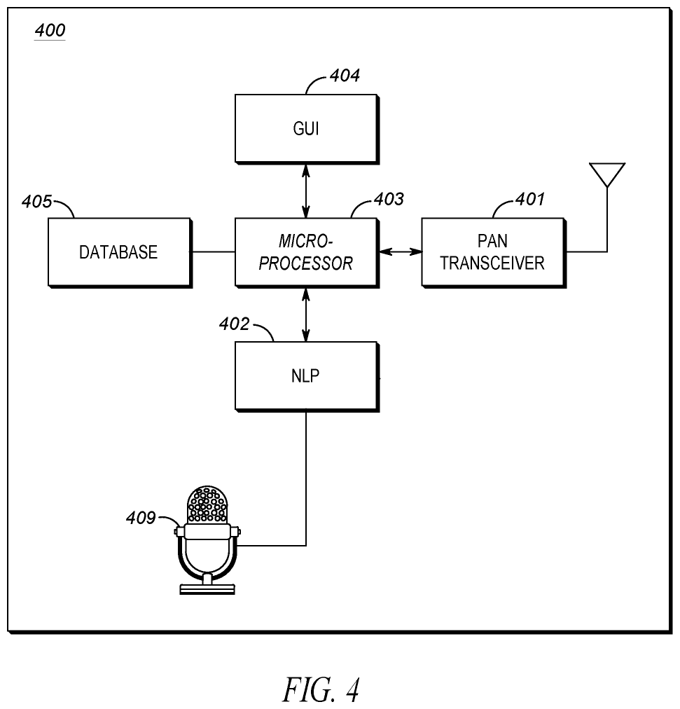

With the above in mind, FIG. 4 sets forth a block diagram of a device 400 to serve as a proxy for hands-free operation of another device 212 remote from device 400. In an embodiment, the device is embodied within hub 102, but one of ordinary skill in the art will recognize that device 400 may be embodied within any device 212 that is desired to be used as a proxy to control another device. As shown, device 400 may include a personal-area network (PAN) transceiver 401, Natural Language Processor (NLP) 402, logic circuitry 403 (which may serve as a digital assistant), database 405, and graphical-user interface (GUI) 404. In other implementations, device 400 may include more, fewer, or different components. Regardless, all components are connected via common data busses as known in the art.

PAN transceiver 401 may be a well known short-range (e.g., 30 feet of range) transceivers that utilize any number of network system protocols. For example, PAN transceiver 401 may be configured to utilize Bluetooth® communication system protocol for a body-area network, or a private 802.11 network.

NLP 402/logic circuitry 403 may be a well known circuitry to analyze, understand, and derive meaning from human language. By utilizing NLP, automatic summarization, translation, named entity recognition, relationship extraction, sentiment analysis, speech recognition, and topic segmentation can take place and thus determine that a user issued a particular command that may be acted on by device 400.

Logic circuitry 403 comprises a digital signal processor (DSP), general purpose microprocessor, a programmable logic device, or application specific integrated circuit (ASIC) and is configured to serve as a proxy for a remote device as described herein by serving as a digital assistant

Database 405 is provided. Database 405 comprises standard memory (such as RAM, ROM, . . . , etc) and serves to store utterances and their associated commands. This is illustrated in Table 1.

TABLE 1
Utterances and their associated commands issued to devices 212.

| Utterance | Command |
|---|---|
| “volume up” | Command to increase volume on radio |
| “record” | Command to instruct camera to begin recording |
| . . . , etc. | . . . , etc. |

Finally, GUI 404 comprises a man/machine interface for receiving an input from a user and displaying information. For example, GUI 404 may provide a way of conveying (e.g., displaying) information received from processor 403. Part of this information may comprise an instruction to a user to record a new utterance associated with a command used to control device 212. Additionally, part of this information may comprise a suggested utterance that will be associated with a command used to control device 212.

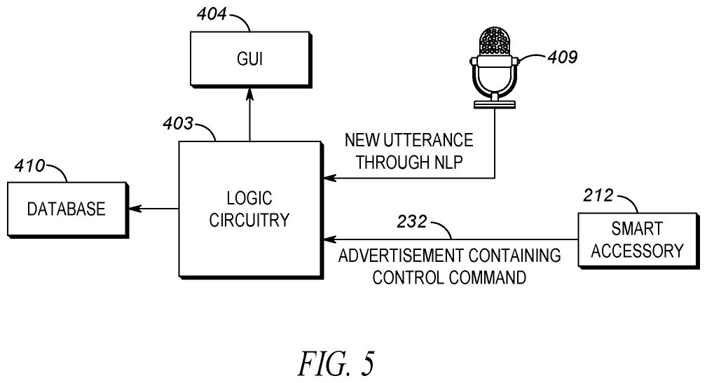

The operation of device 400 is illustrated in FIG. 5. During operation, a user will control a smart device 212 with a non-vocal command. In other words, a user will control device 212 by physically touching knobs, buttons, soft keys, . . . , etc. on device 212 without using any utterance. In response, device 212 will provide an advertisement to logic circuitry 403 (via Bluetooth link 232) that indicates one or more commands that logic circuitry 403 can issue to device 212 that will achieve the same result as the user's non-vocal command. For example, if a user is attempting to record video by pushing a “record” button on device 212, device 212 will begin recording as well as issue an advertisement to logic circuitry 403 containing a command that can be utilized by logic circuitry 403 to instruct device 212 to record.

In alternate example, a user may attempt to adjust the field of view (FOV) of a camera by performing a series of consecutive physically interactions on one or more user interfaces of device 212; device 212 will adjust its FOV in response to said user interactions on its user interface; device 212 will also start a countdown timer upon detection of a first user interaction on device 212's user interface, countdown timer will reset when a second or consecutive user interactions are detected on device 212's user interface; after a last user interaction is performed on device 212's user interface and upon countdown timer expiration, device 212 will issue an advertisement to logic circuit 403 containing one or more consecutive commands that can be utilized by logic circuitry 403 to instruct device 212 to adjust its FOV to same settings as determined by said user interactions.

In embodiments, a user's physically interaction on device 212's user interface may not be limited to actions of touching, pressing or turning a physical button, switch or knob; however, it can be appreciated by those skilled in the arts that said user's physical interactions may also include any non-verbal physical actions performed using any suitable user interface such as a touch, a scroll, a swipe or a combinational gesture performed on a touchscreen user interface.

Once logic circuitry 403 receives this one or more commands, logic circuitry 403 will access database 410 to determine if the one or more commands received in the advertisement is already associated with an utterance. If not, logic circuitry will notify the user (via GUI 404) to record a new utterance that may be associated with the one or more commands received in the advertisement. Alternatively, logic circuitry 403 may recommend an utterance to the user (via GUI 404) that will be associated with the one or more commands received in the advertisement.

When logic circuitry 403 notifies a user to record a new utterance that will be associated with the one or more commands received in the advertisement, logic circuitry 403 will then receive a new utterance from the user through NLP 402 (not shown in FIG. 5) and microphone 409. Logic circuitry 403 will then populate database 410 with the new utterance and associate it in database 410 with the one or more commands received in the advertisement. From this point on, whenever logic circuitry receives the new utterance, it will issue the one or more commands received in the advertisement to smart accessory 212. This allows device 400 to serve as a voice proxy to control device 212.

Alternatively, when logic circuitry 403 notifies a user of the new utterance that will be associated with the one or more commands received in the advertisement, logic circuitry will then populate database 410 with the new utterance and associate it within database 410 with the one or more commands received in the advertisement. From this point on, whenever logic circuitry receives the new utterance, it will issue the one or more commands received in the advertisement to smart accessory 212. This allows device 400 to serve as a voice proxy to control device 212.

In alternate embodiments, a user's physical interactions on one or more user interfaces of device 212 may comprise of a first interaction performed on a first user interface, and second subsequent interactions performed on a second set of user interfaces. First interaction may invoke device 212 to utilize the second subsequent interactions to advertise commands to logic circuitry 403 referencing the second subsequent interactions. For example, a user may press a “send advertisement” button on a camera module before performing consecutive interactions on the camera module's user interfaces to adjust a FOV settings; pressing the “send advertisement” button invokes said camera module to advertise commands referencing the second subsequent interactions needed to adjust the FOV settings of said camera module. In this embodiment, the first interaction constitutes a “trigger” to invoke device 212 to send commands advertisement referencing the second subsequent interactions after the first interaction. Alternatively, device 212 may be configured to always advertise commands in response to any user interactions performed on its user interface without a trigger condition; and rely on logic circuitry 403 to determine if new voice command should be added to database 410.

With the above in mind, FIG. 4 and FIG. 5 illustrate an apparatus comprising a microphone, a graphical-user interface (GUI), a personal-area network (PAN) receiver, a database configured to store utterances and their associated commands used to control a device remote from the apparatus, and logic circuitry. The logic is configured to receive and advertisement from the device via the PAN transceiver, wherein the advertisement comprises a command used to control the device, access the database to determine that the command does not exist within the database, notify a user via the GUI to begin recording a new utterance to associate with the command, record the new utterance from the user utilizing the microphone, and store the new utterance within the database and associate the new utterance with the command.

As discussed, the logic circuitry may be further configured to again receive the new utterance from the user, access the database to determine the command associated with the new utterance, and cause the PAN transceiver to issue the command to the device, thus serving as a proxy to control the device.

Additionally, the advertisement was preferably received in response to a user issuing a non-verbal command to the device.

With the above in mind, the apparatus shown in FIG. 4 and FIG. 5 comprises a database configured to store utterances and their associated commands used to control a device remote from the apparatus. Logic circuitry is provided, and configured to receive and advertisement from the device, wherein the advertisement comprises a command used to control the device, and was received in response to a user controlling the device with a non-verbal command, access the database to determine that the command does not exist within the database, determine a new utterance to associate with the command, store the new utterance within the database associated with the command, receive the new utterance from the user, and cause the command to be transmitted to the device in response to receiving the new utterance from the user.

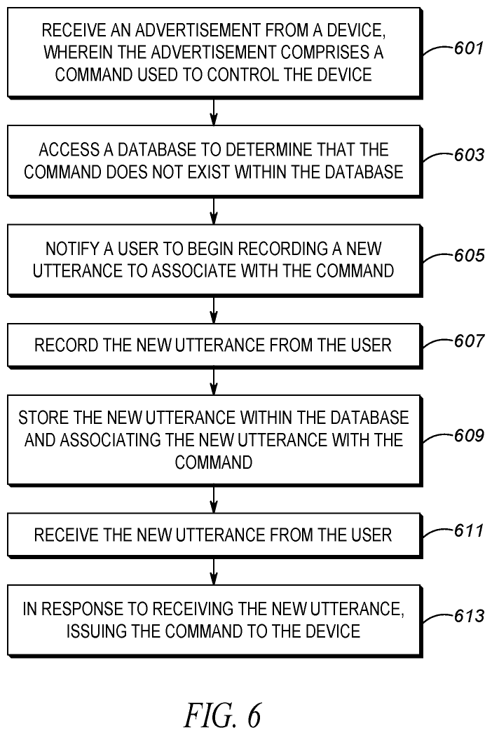

FIG. 6 is a flow chart showing operation of the proxy device shown in FIG. 4 and FIG. 5. The logic flow begins at step 601 where an advertisement is received via a wireless transceiver 401 from device 212. As discussed, the advertisement comprises a command used to control device 212. Additionally, the advertisement was triggered to be sent from device 212 by a user issuing a non-verbal command to control device 212. The advertisement is passed from PAN transceiver 401 to logic circuitry 403.

At step 603, logic circuitry 403 accesses database 405 to determine that the command does not exist within database 405, and notifies a user to begin recording a new utterance to associate with the command (step 605).

The new utterance is recorded from the user at step 607 and stored in the database as being associated with the command (step 609). At step 611 the new utterance is received from the user at microphone 409, and passed to logic circuitry 403. Finally, at step 613, logic circuitry 403 instructs transceiver 401 to issue the command to device 212 in response to receiving the new utterance. More particularly, when logic circuitry 403 receives any utterance, it will check database 405 to determine if the utterance is stored in database 405. If so, the associated command(s) will be sent to device 212.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot [include a particular function/feature from current spec], among other features and functions set forth herein).

In the foregoing specification, specific embodiments have been described. However, one of ordinary skill in the art appreciates that various modifications and changes can be made without departing from the scope of the invention as set forth in the claims below. For example, the use of a PAN was shown for communicating between a proxy device and another device, however, one of ordinary skill in the art will recognize that any wired or wireless network may be utilized for communication purposes. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An apparatus comprising:
a microphone;
a graphical-user interface (GUI);
a personal-area network (PAN) transceiver;
a database configured to store utterances and their associated commands used to control a device remote from the apparatus;
logic circuitry configured to:
receive an advertisement from the device via the PAN transceiver, wherein the advertisement comprises a command used to control the device;
access the database to determine that the command does not exist within the database;
notify a user via the GUI to begin recording a new utterance to associate with the command;
record the new utterance from the user utilizing the microphone; and
store the new utterance within the database and associate the new utterance with the command.

2. The apparatus of claim 1 wherein the logic circuitry is further configured to:
again receive the new utterance from the user;
access the database to determine the command associated with the new utterance; and
cause the PAN transceiver to issue the command to the device.

3. The apparatus of claim 1 the advertisement was received in response to a user issuing a non-verbal command to the device.

4. The apparatus of claim 1 wherein the device comprises a body-worn camera, a smart watch, or an “Internet of things” (IoT) device.

5. An apparatus comprising:
a database configured to store utterances and their associated commands used to control a device remote from the apparatus;
logic circuitry configured to:
receive an advertisement from the device, wherein the advertisement comprises a command used to control the device, and was received in response to a user controlling the device with a non-verbal command;
access the database to determine that the command does not exist within the database;
determine a new utterance to associate with the command; and
store the new utterance within the database associated with the command;
receive the new utterance from the user; and
cause the command to be transmitted to the device in response to receiving the new utterance from the user.

6. The apparatus of claim 5 wherein the device comprises a body-worn camera, a smart watch, or an “Internet of things” (IoT) device.

7. The apparatus of claim 5 further comprising:
a wireless transceiver; and
wherein the logic circuitry is configured to receive the advertisement from the wireless transceiver.

8. A method comprising the steps of:
receiving an advertisement from a device, wherein the advertisement comprises a command used to control the device;
accessing a database to determine that the command does not exist within the database;
notifying a user to begin recording a new utterance to associate with the command;
recording the new utterance from the user;
storing the new utterance within the database and associating the new utterance with the command;
receiving the new utterance from the user; and
in response to receiving the new utterance, issuing the command to the device.

9. The method of claim 8 wherein the step of receiving the advertisement from the device comprises the step of receiving the advertisement in response to the user issuing a non-verbal command to control the device.

10. The method of claim 8 wherein the step of receiving the advertisement from the device comprises the step of receiving the advertisement over a wireless network.
